(19) United States
(12) Patent Application Publication
(10) Pub. No.: US 2014/0311917 A1
(43) Pub. Date: Oct. 23, 2014

(54) HYDROGEN PRODUCTION PROCESS

(71) Applicant: Satish S. Tamhankar, Scotch Plains, NJ (US)

(72) Inventor: Satish S. Tamhankar, Scotch Plains, NJ (US)

(21) Appl. No.: 13/866,173

(22) Filed: Apr. 19, 2013

(51) Int. Cl. C01B 3/26; C25B 1/02

(52) U.S. Cl. CPC C01B 3/26; C25B 1/02
USPC 205/637

(57) ABSTRACT

A method is disclosed for producing high purity, high pressure hydrogen from a low pressure synthesis gas production process. The low pressure synthesis gas is produced from steam or carbon dioxide reforming of hydrocarbons, autothermal reforming of hydrocarbons or partial oxidation of hydrocarbons. The resulting low pressure synthesis gas mixture is fed to an electro-chemical cell wherein hydrogen is separated from the low pressure synthesis gas mixture and subjected to compression and high pressure; high purity hydrogen is recovered from the electro-chemical cell.

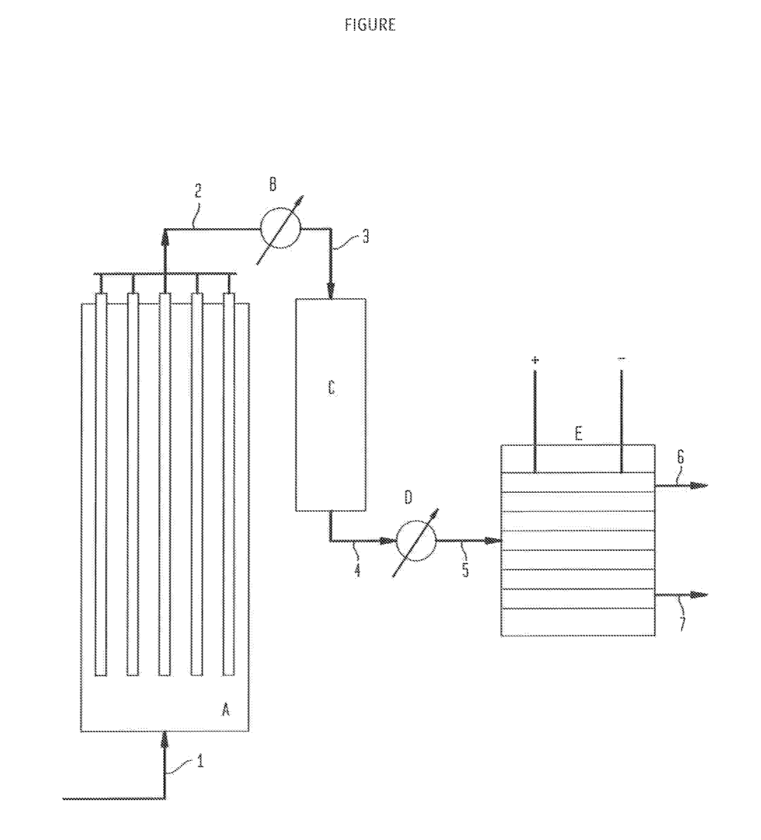

### BACKGROUND OF THE INVENTION

Conventional hydrogen production plants that are based on steam methane reforming (SMR) typically operate at a temperature of 700° to 900° C. and at a pressure of 150 to 500 psig. One primary reason to operate at high pressure is to enable separation of hydrogen from the product synthesis gas using a pressure swing adsorption (PSA) method. However, reforming equilibrium is favored at lower pressures. Operation at high pressure and temperature further demands the use of expensive alloys for the construction of the reformer. Similar concerns arise for other types of hydrogen production processes, such as dry (carbon dioxide) reforming, catalytic or non-catalytic partial oxidation or auto-thermal reforming.

Small scale systems, typically those producing less than 1 ton of hydrogen per day are less efficient economically compared to large scale production technologies due to the higher capital cost contribution to the overall cost of hydrogen produced. Thus, lowering the capital cost of such small plants is a critical need. The proposed approach can lead to such low cost plants.

A low pressure operation such as with an SMR (LPSMR) would result in higher productivity and would allow use of low cost materials of construction. Attempts were made in the past to develop such as system, however, with the use of conventional PSA processes for hydrogen separation, the product syngas from the LPSMR or other like processes needs to be compressed. This is an expensive step compared to the compression of the feed natural gas or the product hydrogen. By eliminating the use of a compressor for the syngas, significant savings can result in terms of operations and construction costs. For example, as noted in US Pat Pub No 2010/0243475 A1, electrochemical processes are known for selectively transferring hydrogen from one side of an electrochemical cell to the other side. These hydrogen pumps may be used to separate hydrogen from gas mixtures containing other components which are not impacted by the electrolysis process.

Furthermore, the present invention provides for the use of low cost construction materials, resulting in significant cost savings. It provides for the production of high purity, high pressure hydrogen while avoiding the need to pressurize the entire synthesis gas mixture. Thus a more cost effective means for hydrogen production results compared to conventional steam methane reforming, dry reforming or partial oxidation processes.

### SUMMARY OF THE INVENTION

In one embodiment of the invention, there is disclosed a method for producing hydrogen comprising the steps:

a) Producing a low pressure synthesis gas mixture from a process selected from the group consisting of steam or carbon dioxide reforming of hydrocarbons, autothermal reforming of hydrocarbons and partial oxidation of hydrocarbons;

b) Feeding the low pressure synthesis gas mixture to an electro-chemical cell wherein hydrogen is separated from the synthesis gas mixture; and

c) Recovering the hydrogen.

For purposes of the invention, low pressure is defined to be about ambient pressure up to about 3 bar.

The low pressure synthesis gas mixture that is produced comprises hydrogen, carbon monoxide, carbon dioxide, methane, water and nitrogen.

The method for producing the low pressure synthesis gas mixture can be by a conventional process selected from the group consisting of steam or carbon dioxide reforming of hydrocarbons, autothermal reforming of hydrocarbons and partial oxidation of hydrocarbons.

The low pressure synthesis gas mixture is typically produced from a hydrocarbon such as methane as the starting material and the low pressure synthesis gas mixture will be at a temperature of 700° to 900° C. when it leaves the production process.

This high temperature, low pressure synthesis gas mixture can be cooled by a cooler prior to it entering the Electro-chemical Hydrogen Separation (EHS) device. In certain operations, the low pressure synthesis gas mixture can be fed to a water gas shift reactor where its hydrogen content will be increased while reducing its carbon monoxide content. This synthesis gas mixture is also at a higher temperature and can also be fed to a cooler prior to it entering the EHS.

The EHS contains an electrolyte membrane comprising a polymer, such as commercial NAFION®, a trademark of E.I. du Pont de Nemours and Company (sulfonated tetrafluroethane copolymer) or Poly Benzyl Immidazole (PBI). These types of membranes are known as Proton Exchange Membranes (PEM), as they selectively allow only hydrogen to pass through. PEM are typically used in fuel cells, and in recent years have been extensively studied, developed and improved in terms of cost and performance. The PEM electrolyte membrane used in the EHS will allow transfer of the hydrogen from the synthesis gas mixture as well as create a waste stream of the other components of the synthesis gas mixture. This waste stream can be disposed of in an environmentally friendly manner, treated or reused in other industrial processes by the operator. For example, if it has sufficient heating value, the waste gas may be used as fuel in the reforming furnace.

The hydrogen that is recovered can also be simultaneously pressurized up to desired pressures of 100 to 200 psig or higher by the EHS by means of applied voltage.

The power requirement for the EHS operation is dependent on a number of factors, such as membrane thickness, area, current density, differential pressure, etc. Typical values may range from 3 to 10 kwh/kg H₂. The number of cells and device architecture also play a role in power consumption. For a given configuration and operating conditions, these parameters can be optimized for the best possible overall cost and performance.

In another embodiment of the invention, there is disclosed a method for producing hydrogen comprising feeding a low pressure synthesis gas mixture to an EHS wherein hydrogen passes through the electrolyte membrane.

The use of the low pressure synthesis gas mixture production processes will allow for lower construction costs as low cost steel can be employed in building the reactor. Further energy efficiencies are realized by the favorable thermodynamic equilibrium realized by operating these processes at low pressure. The direct energy conversion from electrical to pressure in the EHS can result in lower electricity consumption than for conventional mechanical compression means. Further, by separating the hydrogen from the other components of the synthesis gas mixture and compressing only the hydrogen, savings are realized by avoiding compression of these unnecessary components.

Important saving results from the lower capital cost of the ENS devices compared to a combination of a mechanical compressor and a conventional separation system such a Pressure Swing Adsorption (PSA) device or a membrane separation device. Furthermore, use of mechanical compressors is also known to result in high maintenance costs due to wear and tear. On the other hand, EHS has no moving parts, and therefore requires minimal maintenance except for membrane replacement in the event it is inadvertently exposed to unwanted impurities. This should therefore be avoided.

### BRIEF DESCRIPTION OF THE DRAWINGS

The FIGURE is a schematic of a separation process per the invention.

### DETAILED DESCRIPTION OF THE INVENTION

Turning to the FIGURE, there is shown a schematic representation of the synthesis gas mixture generation and hydrogen separation and compression process of the invention.

A stream of steam and hydrocarbon, and optionally air or oxygen, is fed through line 1 into a reactor A for producing a low pressure synthesis gas mixture. The hydrocarbon is typically methane but can be any hydrocarbon that is capable of reacting to form synthesis gas. The reactor is one where a synthesis gas production process can occur. These are typically steam or carbon dioxide reforming of methane or other hydrocarbon feedstocks, autothermal reforming of feedstock hydrocarbons or partial oxidation of methane or hydrocarbon feedstock at the appropriate temperature.

The resulting synthesis gas mixture is at low pressure and comprises hydrogen, carbon monoxide, carbon dioxide, methane and water. In a typical SMR reactor, the synthesis gas produced comprises on a dry basis, 60 to 70% H₂, 5 to 10% CO, and 10 to 15% CO₂. The composition would vary depending on the mode of operation, such as CO₂ reforming, partial oxidation, and other variables as determined by the operator and will leave reactor A through line 2 where it will be fed to an optional cooler B. The synthesis gas mixture will leave optional cooler B through line 3 and be fed to an optional water gas shift reactor C. The water gas shift (WGS) reaction will use a catalyst to increase the hydrogen content while reducing the carbon monoxide content of the synthesis gas mixture. One or two stages of WGS reactors are typically used depending on the end objective. With two stages of the WGS, it is possible to reduce the CO content to <1% with a corresponding increase in the hydrogen content.

The resulting low pressure synthesis gas mixture will exit the water gas shift reactor through line 4 and be fed to optional cooler D before being fed through line 5 to the EHS device E. The EHS device E works through the application of direct current to selectively drive hydrogen from the synthesis gas mixture through an electrolyte membrane. The hydrogen is then subject to compression within the EHS cell where it will be raised in pressure to about 100 to 200 psig or higher as desired. Higher pressures will consume somewhat higher electricity. The purified hydrogen at pressure is recovered through line 6 where it will be fed to storage or to a unit operation where hydrogen is needed. The remaining portion of the synthesis gas mixture is not subject to any compression and is fed through line 7 where it will be treated for release into the atmosphere or forwarded onto another unit operation that could use the components present therein.

The EHS typically comprises a stack of individual cells, each comprising a cathode and an anode separated by the PEM electrolyte. The cathode and the anode have a layer of catalyst, typically a precious metal catalyst such as platinum. Hydrogen molecules in the anode compartment are dissociated on the anode surface and the resulting protons are transported across the PEM to the cathode side where they recombine to form H₂ molecules again. With a set back pressure, the hydrogen exiting the EHS can be obtained at a desired high pressure. The principles and operation of a typical EHS unit is described in the literature (e.g. B. Robland*, K. Eberle, R. Strèbel, J. Scholta and J. Garche; “Electrochemical hydrogen compressor”; Electrochimica Acta, Vol. 43, No. 24, pp. 3841-3846, 1998). Depending on the type of membrane used, the CO in the syngas may have to be removed to low levels (e.g. <200 ppm for the Nafion® type membrane). Also, other trace impurities, if present, such as NH₃, H₂S, HCl, etc. may be detrimental to the membrane and need to be removed. This can be accomplished by using a guard bed in front of the EHS device. This operation is well known. Another consideration is that the operation of the EHS membrane requires the presence of moisture in the gas stream. If the syngas fed to the EHS is dry, a humidifier may be used to introduce moisture in the syngas stream. The product hydrogen from the EHS would then contain some moisture, which can be removed by conventional means such as condensation, absorption or adsorption to obtain desired dry hydrogen product.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for producing hydrogen comprising the steps:
a) Producing a low pressure synthesis gas mixture from a process selected from the group consisting of steam or carbon dioxide reforming of hydrocarbons, autothermal reforming of hydrocarbons and partial oxidation of hydrocarbons;
b) Feeding the low pressure synthesis gas mixture to an electro-chemical cell wherein hydrogen is separated from the low pressure synthesis gas mixture; and
c) Recovering the hydrogen.

2. The method as claimed in claim 1 wherein the low pressure synthesis gas mixture comprises hydrogen, carbon monoxide, carbon dioxide, methane and water.

3. The method as claimed in claim 1 wherein the low pressure synthesis gas mixture is produced at a temperature of 700° to 900° C.

4. The method as claimed in claim 1 wherein the low pressure synthesis gas is at ambient pressure.

5. The method as claimed in claim 1 wherein said hydrocarbon is methane.

6. The method as claimed in claim 1 wherein the low pressure synthesis gas mixture is cooled after leaving the production process.

7. The method as claimed in claim 1 wherein the low pressure synthesis gas mixture is fed to a water gas shift reactor prior to being fed to the electro-chemical cell.

8. The method as claimed in claim 1 further comprising cooling the low pressure synthesis gas mixture leaving the water gas shift reactor.

9. The method as claimed in claim 1 wherein the electro-chemical cell generates a waste gas stream.

10. The method as claimed in claim 1 wherein the hydrogen is compressed within the electrochemical cell with applied voltage to a pressure of 100 to 200 psig.

11. The method as claimed in claim 1 wherein the electro-chemical cell contains a proton exchange electrolyte membrane.

12. The method as claimed in claim 11 wherein the proton exchange membrane is selected from the group consisting of sulfonated tetrafluorethane copolymer and poly benzyl immidazole.

13-25. (canceled)
